(19) United States
(12) Patent Application Publication
(10) Pub. No.: US 2008/0255824 A1
(43) Pub. Date: Oct. 16, 2008

(54) Translation Apparatus

(75) Inventor: Yuuichiro Aso, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 10/586,140

(22) PCT Filed: Jan. 11, 2005
(86) PCT No.: PCT/JP05/00185

§ 371 Date: Jul. 17, 2006

(30) Foreign Application Priority Data
Jan. 19, 2004 (JP) P2004-011014

(51) Int. Cl. G06F 17/28; G10L 15/26; G10L 13/00

(52) U.S. Cl. 704/2; 704/235; 704/260

(57) ABSTRACT

A translation apparatus includes a punctuation symbol detection unit for detecting whether a predetermined punctuation symbol exists or not in text information of a first language which is obtained by a voice recognition unit. When the punctuation symbol is detected by the punctuation symbol detection unit, the text information of the first language is translated into text information of a second language. As a result of this, in performing translation, it is possible to easily and smoothly obtain a translation result which is intended by a user.

### TECHNICAL FIELD

The present invention relates to a translation apparatus for performing translation.

### BACKGROUND

A translation apparatus which translates inputted voice and outputs voice is employed. The technology is disclosed in which translation is performed by detecting a voiceless period for a predetermined period of time, thereby smoothly obtaining a translation result by voice without a user using a man-machine interface such as a button. (refer to Patent Document 1)

Patent Document 1: JP-B2 2-7107

### DISCLOSURE OF THE INVENTION

According to the aforementioned method, whether a user inputs a silence on purpose for starting translation or the user inputs the silence because of hesitation in speech or during thought is difficult to determine on an apparatus side, as a result of which the translation can be started at timing unintended by a user. Such translation produces results unintended by the user. Additionally, if the translation can be performed via a network, interlingual interaction between remote places becomes easier.

The present invention is made in view of the above circumstances, and its object is to provide a translation apparatus which can easily and smoothly obtain a translation result which is intended by the user, in performing the translation.

The translation apparatus according to the present invention comprises: a punctuation symbol detection unit detecting whether a predetermined punctuation symbol exists or not in text information of a first language; and a translation unit translating the text information of the first language into text information of a second language which is different from the first language, when the punctuation symbol is detected by the punctuation symbol detection unit.

The translation apparatus includes the punctuation symbol detection unit detecting whether the predetermined punctuation symbol exists or not in the text information of the first language which is obtained by the voice recognition unit. When the punctuation symbol is detected by the punctuation symbol detection unit, the text information of the first language is translated into the text information of the second language. Thereby, not only a man-machine interface such as a button is not necessary to start the translation, but also the translation is not started at improper timing. As a result of this, it is possible to obtain a translation result which is intended by the user more smoothly.

### BRIEF DESCRIPTION OF THE DRAWINGS

FIG. 1 is a block diagram showing the structure of a transmission/reception system according to a first embodiment of the present invention.

FIG. 2 is a flowchart showing an operation procedure of the transmission/reception system shown in FIG. 1.

FIG. 3 is a view showing an example of a display screen of a transmission apparatus shown in FIG. 1.

FIG. 4 is a view showing an example of a setting window.

FIG. 5 is a view showing an example of a display screen of a reception apparatus shown in FIG. 1.

FIG. 6 is a block diagram showing the structure of a transmission/reception system according to a second embodiment of the present invention.

FIG. 7 is a flowchart showing an operation procedure of the transmission/reception system shown in FIG. 6.

FIG. 8 is a view showing an example of a display screen of a transmission apparatus shown in FIG. 6.

FIG. 9 is a view showing an example of a display screen of a reception apparatus shown in FIG. 6.

FIG. 10 is a view showing an example of a setting window.

FIG. 11 is a block diagram showing the structure of a transmission/reception system according to a third embodiment of the present invention.

FIG. 12 is a flowchart showing an operation procedure of the transmission/reception system shown in FIG. 11.

FIG. 13 is a view showing an example of a display screen of a transmission apparatus shown in FIG. 11.

FIG. 14 is a view showing an example of a display screen of a reception apparatus shown in FIG. 11.

FIG. 15 is a view showing an example of a setting window.

FIG. 16 is a block diagram showing the structure of a transmission/reception system according to a fourth embodiment of the present invention.

FIG. 17 is a flowchart showing an operation procedure of the transmission/reception system shown in FIG. 16.

FIG. 18 is a block diagram showing the structure of a transmission/reception system according to a fifth embodiment of the present invention.

FIG. 19 is a flowchart showing an operation procedure of the transmission/reception system shown in FIG. 18.

FIG. 20 is a block diagram showing the structure of a transmission/reception system according to a sixth embodiment of the present invention.

FIG. 21 is a flowchart showing an operation procedure of the transmission/reception system shown in FIG. 20.

### BEST MODE FOR IMPLEMENTING THE INVENTION

Hereinafter, embodiments of the present invention will be explained with reference to the drawings.

### First Embodiment

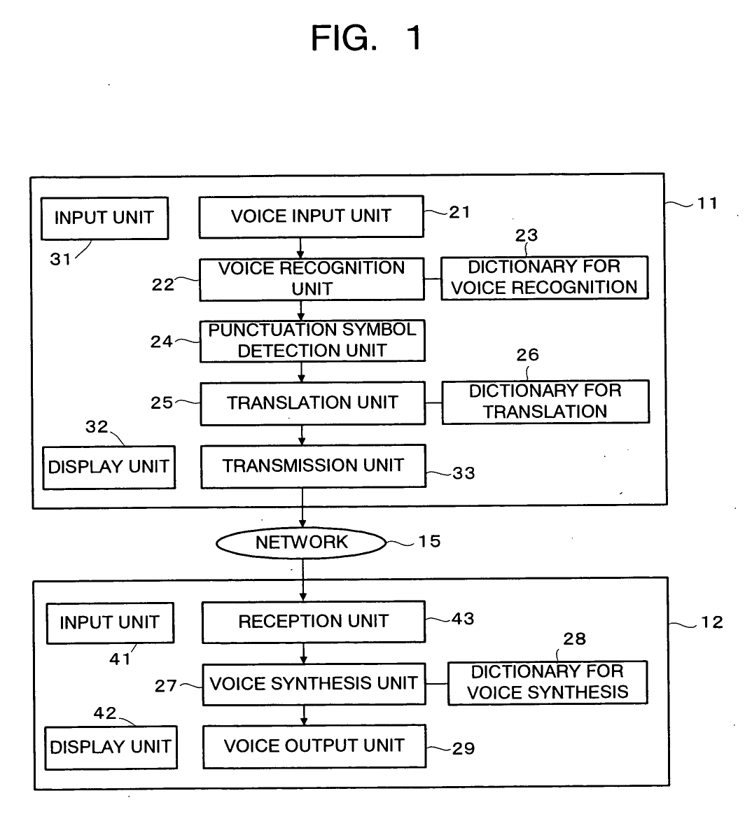

FIG. 1 is a block diagram showing the structure of a transmission/reception system 10 according to a first embodiment of the present invention.

The transmission/reception system 10 has a transmission apparatus 11 and a reception apparatus 12 which are connected via a network 15. The transmission apparatus 11 includes a voice input unit 21, a voice recognition unit 22, a dictionary for voice recognition 23, a punctuation symbol detection unit 24, a translation unit 25, a dictionary for translation 26, an input unit 31, a display unit 32, and a transmission unit 33. The reception apparatus 12 includes a voice synthesis unit 27, a dictionary for voice synthesis 28, a voice output unit 29, an input unit 41, a display unit 42, and a reception unit 43.

Each of the transmission apparatus 11 and the reception apparatus 12 can be constituted by hardware and software. The hardware is information processing equipment such as a computer consisting of a microprocessor, a memory and the like. The software is an operating system (OS), an application program and the like which operate on the hardware. The transmission apparatus 11 and the reception apparatus 12 can be constituted by either general-purpose information processing equipment such as the computer or dedicated equipment. Incidentally, the computer may include a personal computer and a PDA (general-purpose portable terminal device).

The voice input unit 21 converts inputted voice of a first language (Japanese, for example) into electric signals, which is a microphone, for example. The electric signals obtained by the conversion are sent to the voice recognition unit 22.

The voice recognition unit 22 performs a series of processing of voice recognizing the electric signals corresponding to the inputted voice, and converting them into text information of the first language (Japanese). At this time, the dictionary for voice recognition 23 is used as necessary for the conversion into the text information. The text information obtained at the voice recognition unit 22 is sequentially sent to the punctuation symbol detection unit 24. At the voice recognition unit 22, the inputted first language is analyzed so that explicit or implicit punctuation is inserted into the text information of the first language. This will be described later in detail.

The dictionary for voice recognition 23 is a kind of database in which feature values as voice signals and information of text format are correspond to each other, which can be constituted on the memory of the computer.

The punctuation symbol detection unit 24 detects whether punctuation symbols exist or not in the sent text information. The punctuation symbol can be chosen in line with the first language and, for example, three of “.”, “?”, and “!” can be regarded as the punctuation symbols. When the punctuation symbol is detected, the text information up to the symbol is sent to the translation unit 25.

The translation unit 25 performs a series of processing of translating/converting the sent text information of the first language into text information of a second language (English, for example). At this time, the dictionary for translation 26 is used as necessary for the conversion into the text information of the second language. The text information obtained at the translation unit 25 is sent to the transmission unit 33.

The dictionary for translation 26 is a kind of database in which corresponding data of the first language text to the second language text and the like are stored, which can be constituted on the memory of the computer.

The input unit 31 is an input device such as a keyboard and a mouse. The display unit 32 is a display device such as an LCD and a CRT. The transmission unit 33 transmits the text information of the second language which is translated at the translation unit 25 to the reception apparatus 12 via the network 15.

The voice synthesis unit 27 performs voice synthesis based on the text information of the second language. At this time, the dictionary for voice synthesis 28 is used as necessary for the voice synthesis. Voice signals of the second language obtained at the voice synthesis unit 27 are sent to the voice output unit 29.

The dictionary for voice synthesis 28 is a kind of database in which information of the second language of text format and voice signal data of the second language are correspond to each other, which can be constituted on the memory of the computer.

The voice output unit 29 converts the sent voice signals into voice, which is a speaker, for example.

The input unit 41 is an input device such as a keyboard and a mouse. The display unit 42 is a display device such as an LCD and a CRT. The transmission unit 43 receives the text information of the second language from the transmission apparatus 11 via the network 15.

### (Operation of Transmission/Reception System 10)

Next, the operation of the above-described transmission/reception system 10 will be explained.

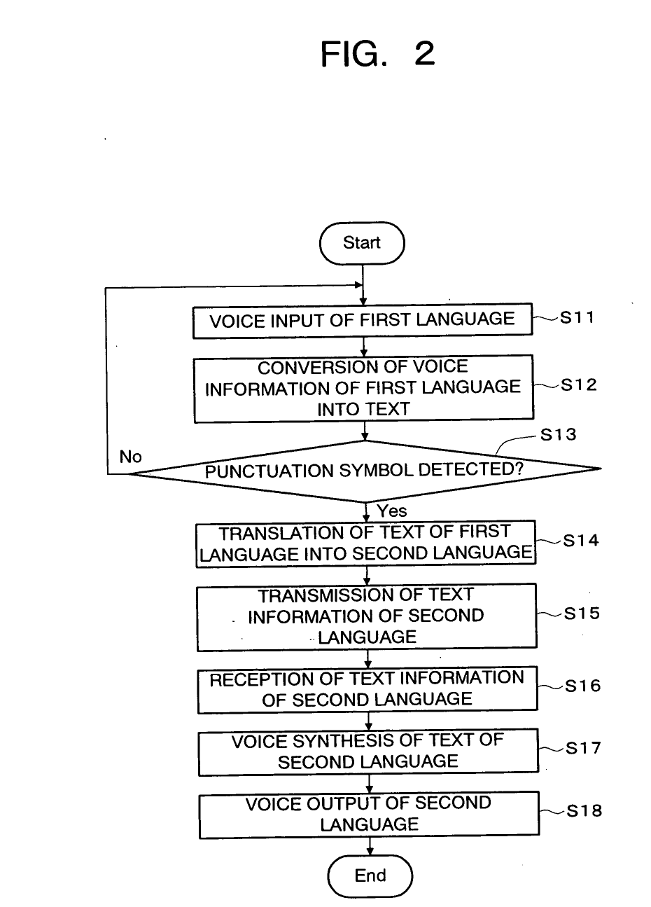

FIG. 2 is a flowchart showing an operation procedure of the transmission/reception system 10 shown in FIG. 1.

Voice of the first language (Japanese, for example) is inputted by the voice input unit 21 (step S11). The voice recognition unit 22 sequentially converts the voice signals of the first language into the text information (step S12).

As one of the methods of the conversion into the text information, the method of inputting the explicit punctuation by voice and converting it into the punctuation symbol as the text may be employed. For example, “maru (period)”, “kuten (period)” and so on for “.”, “question mark”, “hatena mark (question mark)” and so on for “?”, and “exclamation mark”, “bikkuri mark (exclamation mark)” and so on for “!” are inputted by voice, thereby converting these voice signals into “.”, “?” and “!” as the text information. In other words, the “explicit punctuation” is the voice such as “maru”, “kuten” or the like for “.”, and such a voice input can be converted into the text information of the punctuation symbol.

As another method of the conversion into the text information, the method of analyzing information which is voice made into text as it is, thereby judging whether the punctuation symbol such as “.” should be inserted therein or not as the text information, and inserting the punctuation symbol automatically may also be employed. According to this method, usability for a user further improves since it is not necessary to input the explicit punctuation by voice.

This means that, according to this method, the implicit punctuation is inputted by voice. Namely, the “implicit punctuation” is a sentence expression which can be judged to be used as the punctuation from analysis of sentence context and the like. Whether the punctuation symbol for the language should be inserted therein or not is judged by applying various language analyses, so that the punctuation symbol can be automatically added/inserted based on the result of the judgment. Moreover, the punctuation symbol can be inserted when there is a silence of voice (voiceless period) after a sentence end express ion which is used at the end of the sentence. For example, when there is the silence of voice after “desu” or “masu” at the end of the sentence, “.” is inserted therein like “desu.” or “masu.”.

Incidentally, such a text analysis increases a load on software processing. Therefore, only a part of the punctuation symbols are inputted as the implicit voice input, or alternatively, all of these are inputted as the explicit voice input, thereby reducing the processing load.

The information which includes the punctuation symbol and is converted into the text as descried above is sent to the punctuation symbol detection unit 24. The punctuation symbol detection unit 24 sequentially detects whether the punctuation symbol exists or not in the sent text information (step S13).

While the punctuation symbol is not detected, the above processing is performed by returning to the above step S11 again. When the punctuation symbol is detected, the text information of the first language which is sent up to the symbol is transferred to the translation unit 25. In other words, translation at the translation unit 25 is based on the sentence divided by every punctuation.

The translation unit 25 translates/converts the sent text information into the text information of the second language (step S14).

When the processing until the translation and display is performed as described above, it is possible for the user to automatically convert the voice of the first language with the appropriate punctuation into the text information of the second language only by voice, without operating a button or mouse as an interface to the apparatus.

The translated text information of the second language is transmitted from the transmission unit 33 to the network 15 (step S15).

The reception unit 43 of the reception apparatus 12 receives the text information of the second language from the network 15 (step S16).

The voice synthesis unit 27 converts the text information of the second language which is received at the reception unit 43 into voice information of the second language (step S17).

Further, the voice information of the second language which is converted into the voice information is sent to the voice output unit 29, whereby voice output of the second language can be obtained.

As described thus far, according to this embodiment, the translation is automatically started by the detection of the symbol for terminating the sentence, in consideration of the expression until the sentence end. Therefore, not only a man-machine interface such as the button is not necessary to start the translation, but also the translation is not started at improper timing. As a result of this, it is possible to obtain the translation result (text information or voice) which is intended by the user more smoothly.

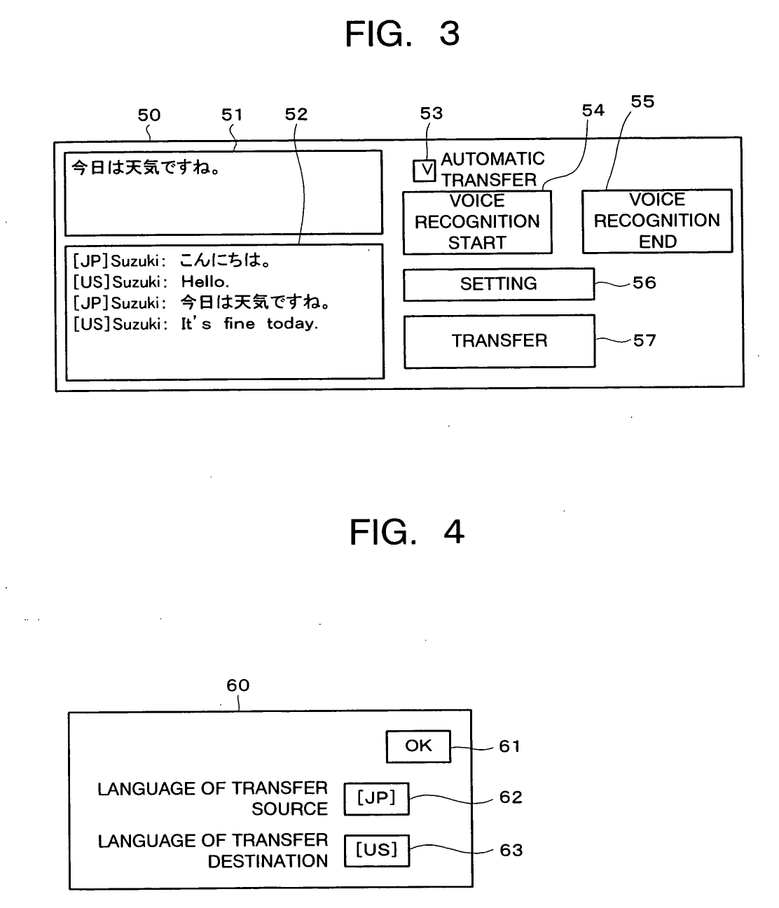

FIG. 3 to FIG. 5 are views each showing an example of a display screen when the computer is used as the transmission apparatus 11 and the reception apparatus 12 as described in FIG. 1.

FIG. 3 shows an example of a display screen 50 of the transmission apparatus 11.

On the display screen 50, an editing window 51, a log window 52, an automatic transfer check box 53, a voice recognition start button 54, a voice recognition end button 55, a setting button 56, and transfer button 57 are displayed.

On the editing window 51, the text information of the first language which is converted at the voice recognition unit 22 is displayed. The text before the translation is displayed here, and an error in the voice input can be corrected using the input unit 31.

On the log window 52, the text before and after the translation is displayed, and the text from the start of the voice recognition until the end thereof is displayed.

The automatic transfer check box 53 is an area to be checked when the automatic transfer is performed. FIG. 3 shows a state of the automatic transfer.

The “automatic transfer” means that the translation and transfer of the translation result are automatically performed when the punctuation symbol is detected. In other words, according to the “automatic transfer”, the translation and transfer are automatically performed with every punctuation included in the text information of the first language, and hence it is not necessary for the user to provide instructions for the translation and transfer.

When the automatic transfer check box 53 is not checked, it means “manual transfer”, in which the translation and transfer are performed by clicking the transfer button 57.

The voice recognition start button 54 and the voice recognition end button 55 are the buttons for starting and ending the voice recognition, respectively.

The setting button 56 is the button for various settings. When this button is clicked with the mouse, a setting window will pop up. Incidentally, the setting window will be described later.

The transfer button 57 is the button for providing instructions for the translation and transfer in the case of the “manual transfer”. When this button is clicked, the text displayed on the editing window 51 is translated and transferred. In this case, the translation and transfer after the input contents are edited on the editing window 51 are possible, and hence an error in the voice input and recognition can be corrected.

FIG. 4 is a view showing an example of a setting window 60. On the setting window 60, a confirmation button 61, a transfer source language input box 62, and a transfer destination language input box 63 are displayed.

The confirmation button 61 is the button for confirming and setting the contents inputted into the transfer source language input box 62 and the transfer destination language input box 63. The transfer source language input box 62 is an input area into which information about a transfer origin language (first language) is inputted. In the drawing, “JP” is inputted, indicating that the first language is Japanese. The transfer destination language input box 63 is an input area into which information about a transfer destination language (second language) is inputted. In the drawing, “US” is inputted, indicating that the second language is English.

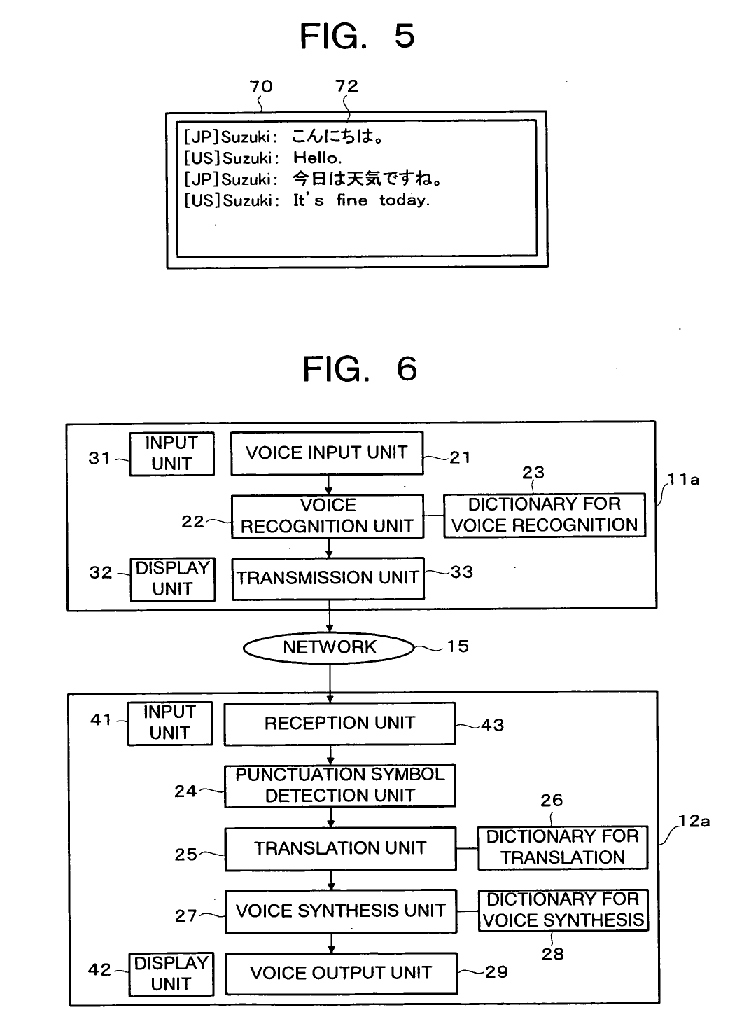

FIG. 5 is a view showing an example of a display screen 70 of the reception apparatus 12. On the display screen 70, a log window 72 is displayed. This log window 72 corresponds to the log window 52. Namely, the text information of the first and second languages before and after the translation is transmitted from the transmission apparatus 11 to the reception apparatus 12.

### Second Embodiment

FIG. 6 is a block diagram showing the structure of a transmission/reception system 10a according to a second embodiment of the present invention. The transmission/reception system 10a has a transmission apparatus 11a and a reception apparatus 12a which are connected via a network 15.

The transmission apparatus 11a includes a voice input unit 21, a voice recognition unit 22, a dictionary for voice recognition 23, an input unit 31, a display unit 32, and a transmission unit 33. The reception apparatus 12a includes a punctuation symbol detection unit 24, a translation unit 25, a dictionary for translation 26, a voice synthesis unit 27, a dictionary for voice synthesis 28, a voice output unit 29, an input unit 41, a display unit 42, and a reception unit 43.

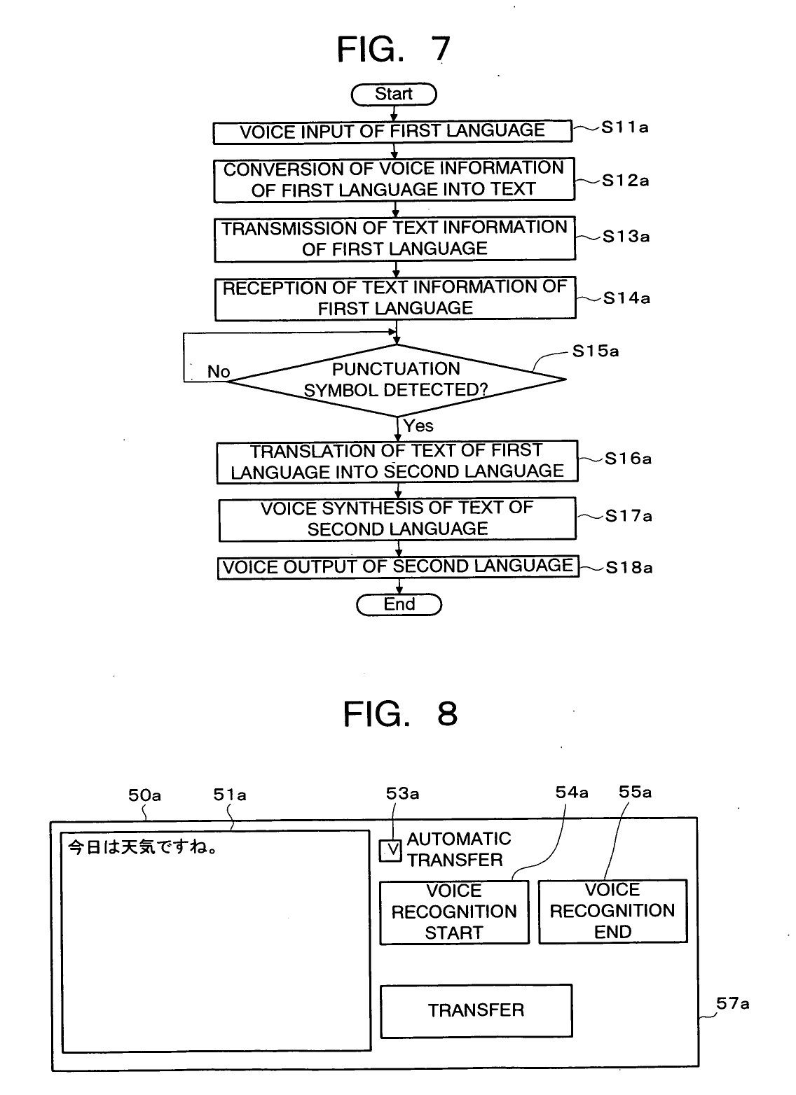

FIG. 7 is a flowchart showing an operation procedure of the transmission/reception system 10a shown in FIG. 6. According to the transmission/reception system 10a, tasks assigned to a transmission side and a reception side are different from those of the transmission/reception system 10. Namely, the translation function is arranged on the reception side. It should be noted that, since the operation of the transmission/reception system 10a as a system in general is not essentially different from that of the transmission/reception system 10, detailed explanation will be omitted.

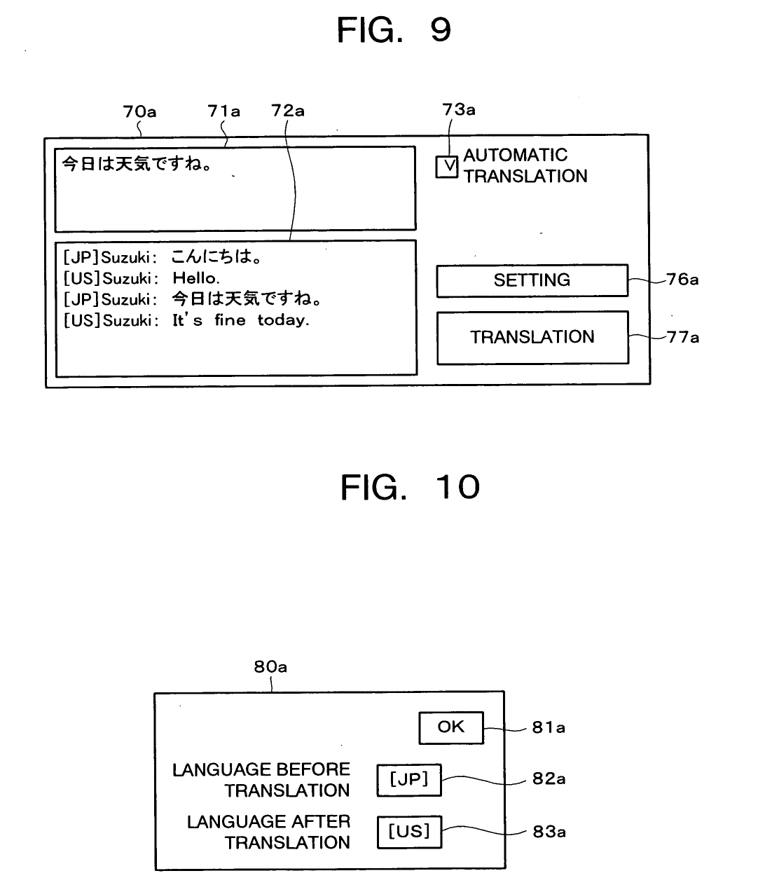

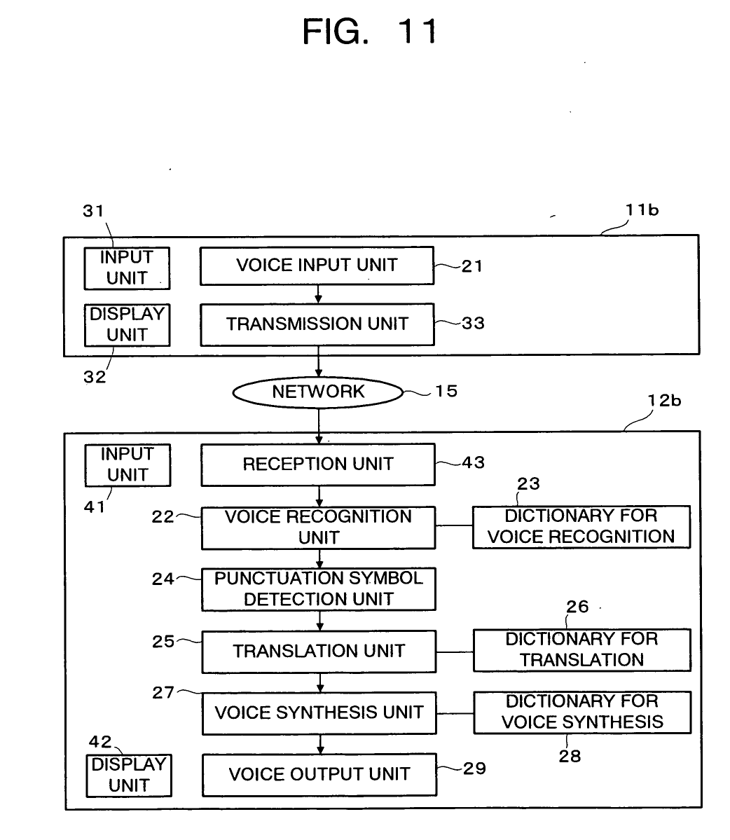

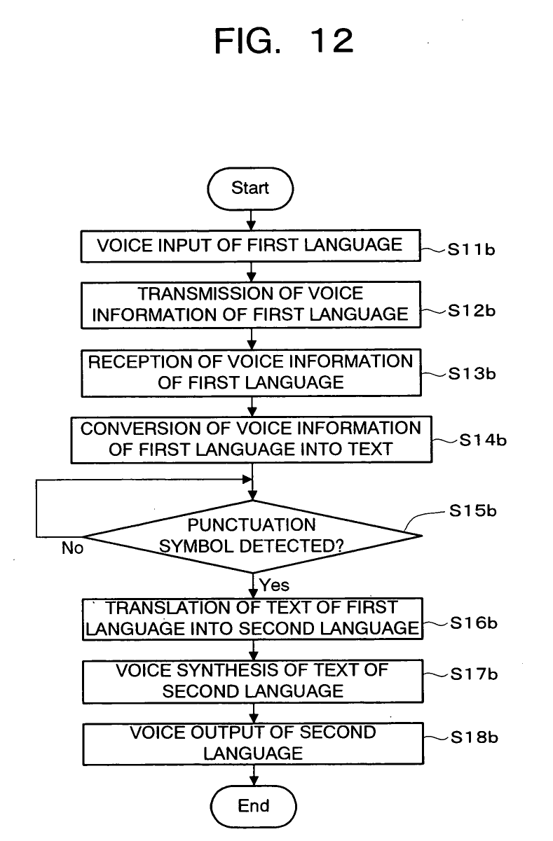

FIG. 8 to FIG. 10 are views each showing an example of a display screen when the computer is used as the transmission apparatus 11a and the reception apparatus 12a as described in FIG. 6. FIG. 8 shows a display screen 50a of the transmission apparatus 11a. FIG. 9 shows a display screen 70a of the reception system 12a. FIG. 10 shows a setting window 80a which pops up when a setting button 76a of the reception apparatus 12a is clicked.

As shown in FIG. 8 to FIG. 10, displayed contents are partly different from those shown in FIG. 3 to FIG. 5, because of the tasks assigned to the transmission apparatus 11a and the reception apparatus 12a. More specifically, editing windows 51a and 71a are respectively displayed on the transmission apparatus 11a and the reception apparatus 12a, but a log window 72a and the setting button 76a are displayed only on the reception apparatus 12a. Additionally, an automatic transfer check box 53a and an automatic translation check box 73a are displayed on the transmission apparatus 11a and the reception apparatus 12a, respectively. This corresponds to the fact that the translation function is shifted to the reception apparatus 12a side.

The automatic transfer checkbox 53a is an area to be checked when automatic transfer is performed. FIG. 8 shows a state of the automatic transfer. Incidentally, the “automatic transfer” means that the text which is converted at the voice recognition unit 22 and is not yet translated is transferred automatically. When the automatic transfer check box 53a is not checked, it means “manual transfer”, in which the transfer is performed by clicking the transfer button 57a, and editing on the editing window 51a before the transfer is possible. It is also possible to perform the transfer every time a punctuation symbol is detected.

The automatic translation check box 73a is an area to be checked when automatic translation is performed. FIG. 9 shows a state of the automatic translation. The “automatic translation” means that the text is translated automatically when the punctuation symbol is detected. When the automatic translation check box 73a is not checked, it means “manual translation”, in which the translation is performed by clicking the translation button 77a.

### Third Embodiment

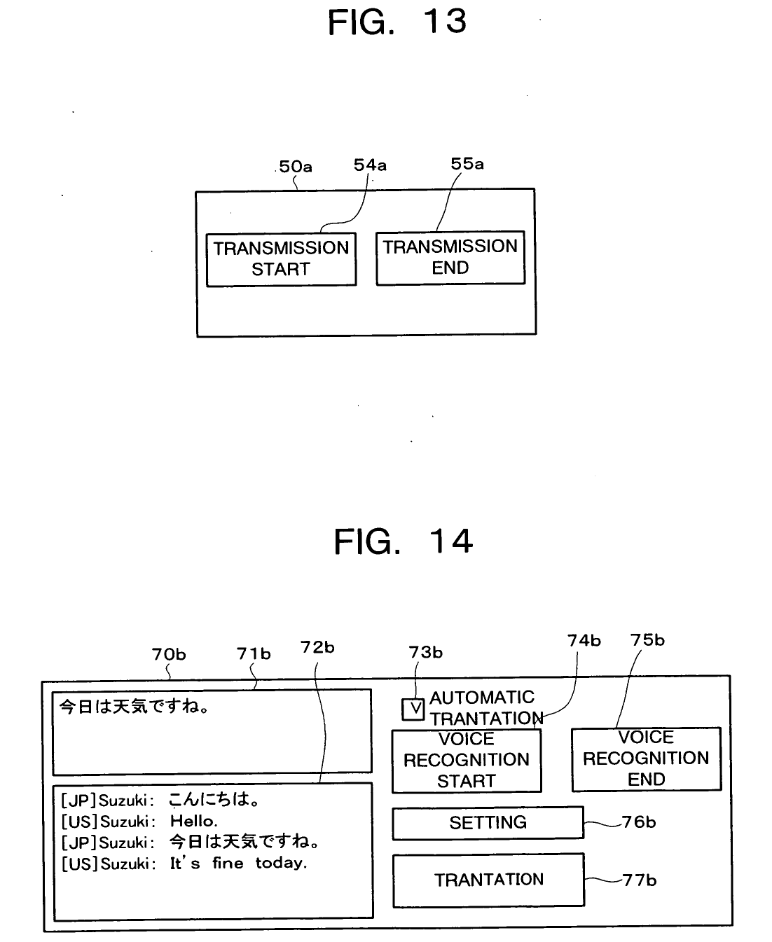

FIG. 11 is a block diagram showing the structure of a transmission/reception system 10b according to a third embodiment of the present invention. The transmission/reception system 10b has a transmission apparatus 11b and a reception apparatus 12b which are connected via a network 15. The transmission apparatus 11b includes a voice input unit 21, an input unit 31, a display unit 32, and a transmission unit 33. The reception apparatus 12b includes a voice recognition unit 22, a dictionary for voice recognition 23, a punctuation symbol detection unit 24, a translation unit 25, a dictionary for translation 26, a voice synthesis unit 27, a dictionary for voice synthesis 28, a voice output unit 29, an input unit 41, a display unit 42, and a reception unit 43.

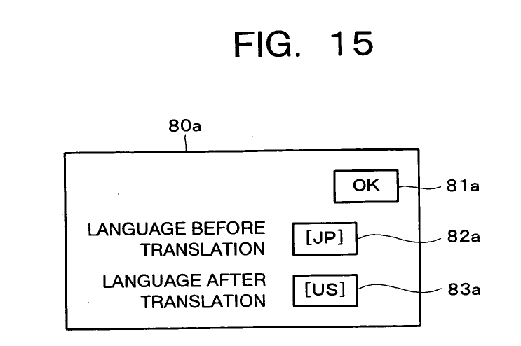

FIG. 12 is a flowchart showing an operation procedure of the transmission/reception system 10b shown in FIG. 11. According to the transmission/reception system 10b, tasks assigned to a transmission side and a reception side are different from those of the transmission/reception systems 10 and 10a. Namely, the voice recognition unit 22 is arranged on the reception side. It should be noted that, since the operation of the transmission/reception system 10b as a system in general is not essentially different from that of the transmission/reception systems 10 and 10a, detailed explanation will be omitted.

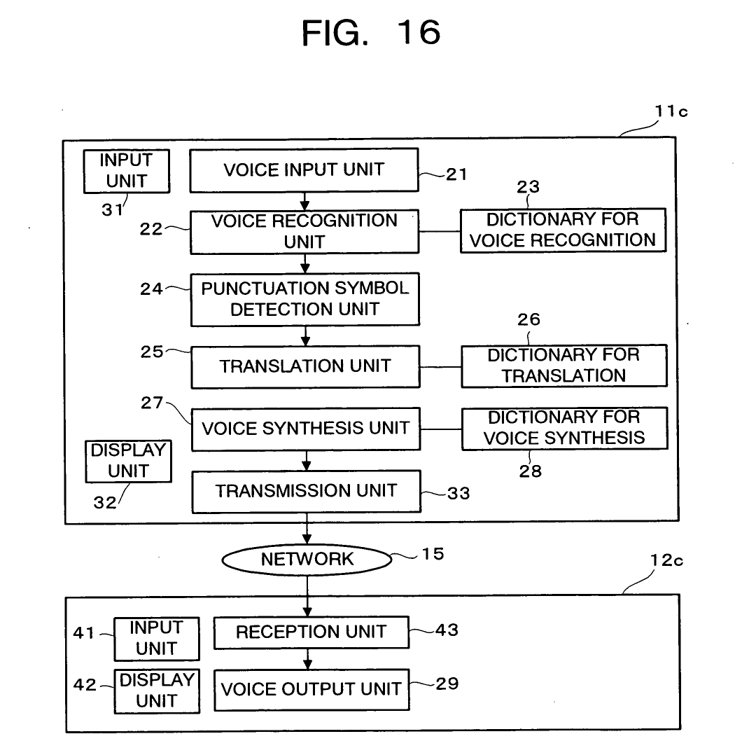

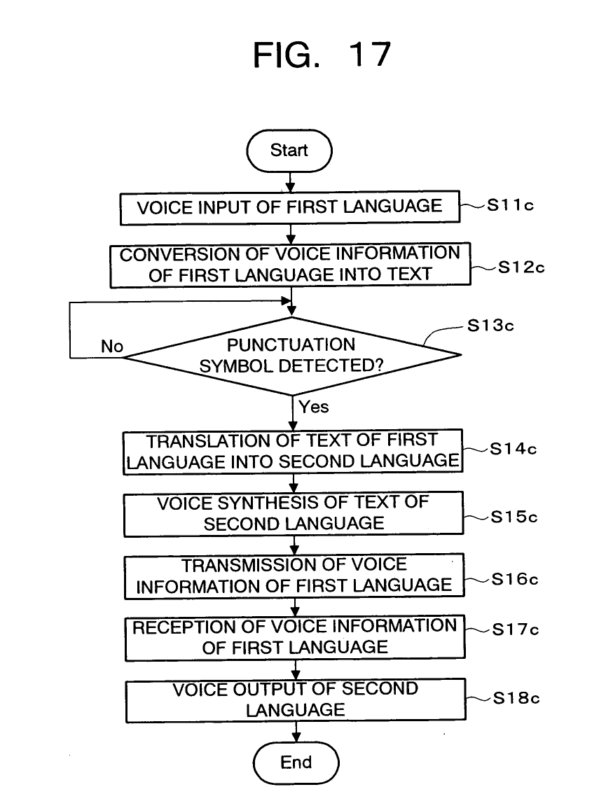

FIG. 13 to FIG. 15 are views each showing an example of a display screen when the computer is used as the transmission apparatus 11b and the reception apparatus 12b as described in FIG. 11. FIG. 13 shows a display screen 50b of the transmission apparatus 11b. FIG. 14 shows a display screen 70b of the reception apparatus 12b. FIG. 15 shows a setting window 80b which pop up when a setting button 76b of the reception apparatus 12b is clicked.

As shown in FIG. 8 to FIG. 10, displayed contents are partly different from those shown in FIG. 3 to FIG. 5 and in FIG. 8 to FIG. 10, because of the tasks assigned to the transmission apparatus 11b and the reception apparatus 12b. More specifically, only a transmission start button 54b and a transmission end button 55b which provide instructions for start and end of transmission are displayed on the display screen 50b of the transmission apparatus 11b. This corresponds to the fact that the reception apparatus 12b side virtually has voice input and transmission functions only.

### Fourth Embodiment

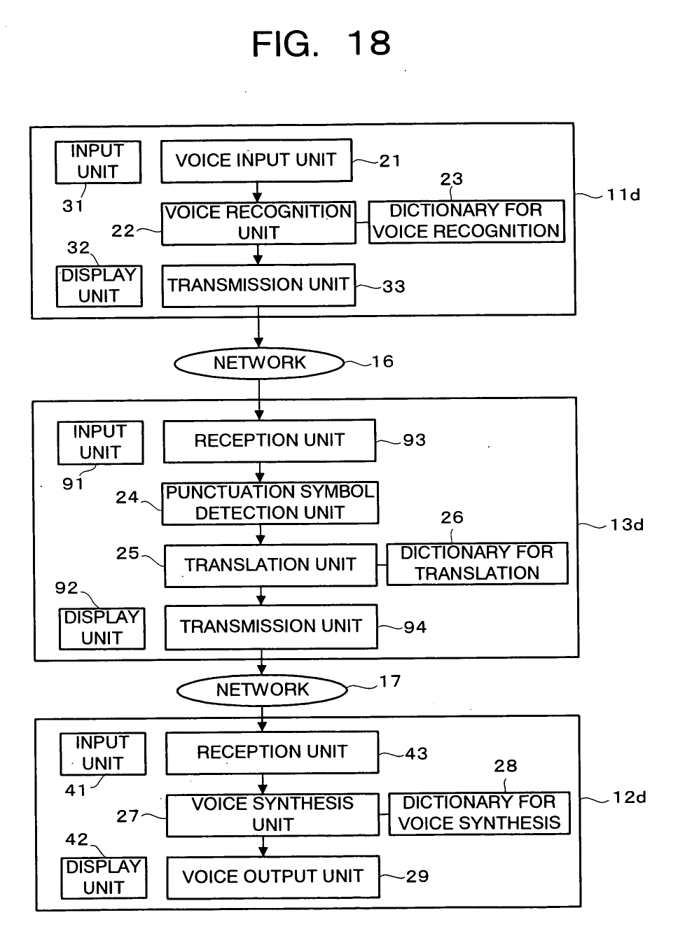

FIG. 16 is a block diagram showing the structure of a transmission/reception system 10c according to a fourth embodiment of the present invention. The transmission/reception system 10c has a transmission apparatus 11c and a reception apparatus 12c which are connected via a network 15. The transmission apparatus 11c includes a voice input unit 21, a voice recognition unit 22, a dictionary for voice recognition 23, a punctuation symbol detection unit 24, a translation unit 25, a dictionary for translation 26, a voice synthesis unit 27, a dictionary for voice synthesis 28, an input unit 31, a display unit 32, and a transmission unit 33. The reception apparatus 12c includes a voice output unit 29, an input unit 41, a display unit 42, and a reception unit 43.

FIG. 17 is a flowchart showing an operation procedure of the transmission/reception system 10c shown in FIG. 16. According to the transmission/reception system 10c, tasks assigned to a transmission side and a reception side are different from those of the transmission/reception systems 10, 10a and 10b. It should be noted that, since the operation of the transmission/reception system 10c as a system in general is not essentially different from that of the transmission/reception systems 10, 10a and 10b, detailed explanation will be omitted.

### Fifth Embodiment

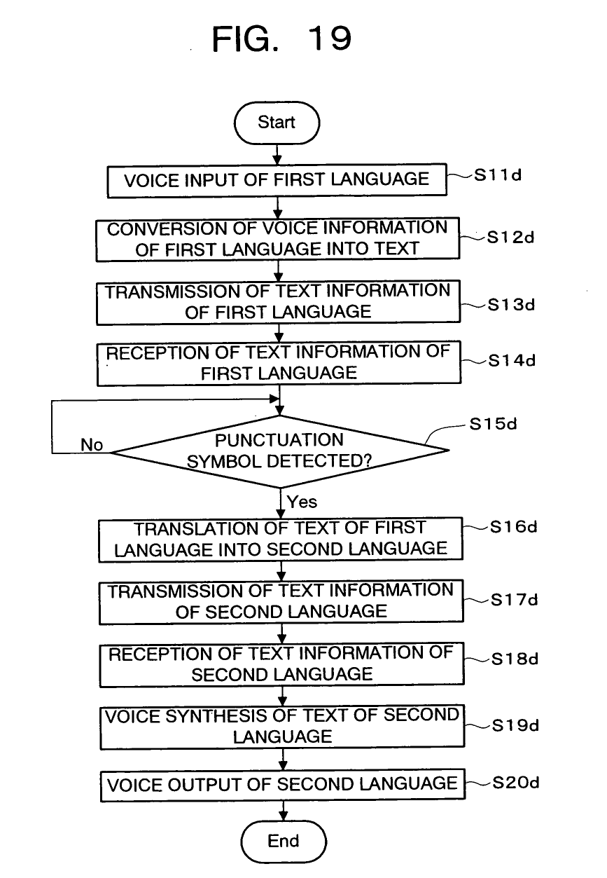

FIG. 18 is a block diagram showing the structure of a transmission/reception system 10d according to a fifth embodiment of the present invention. The transmission/reception system 10d has a transmission apparatus 11d, an interconnection apparatus 13d, and a reception apparatus 12d which are connected via networks 16 and 17. The transmission apparatus 11d includes a voice input unit 21, a voice recognition unit 22, a dictionary for voice recognition 23, an input unit 31, a display unit 32, and a transmission unit 33. The interconnection apparatus 13d includes a punctuation symbol detection unit 24, a translation unit 25, a dictionary for translation 26, an input unit 91, an output unit 92, a reception unit 93, and a transmission unit 94. The reception apparatus 12d includes a voice synthesis unit 27, a dictionary for voice synthesis 28, a voice output unit 29, an input unit 41, a display unit 42, and a reception unit 43.

According to this embodiment, the interconnection apparatus 13d constitutes a part of the transmission/reception system 10d to perform translation. This interconnection apparatus 13d can be constituted by hardware which is information processing equipment such as a computer consisting of a microprocessor, a memory and the like, and software which is an operating system (OS), an application program and the like operating on the hardware. It should be noted that the interconnection apparatus 13d as a whole can be constituted without using the general-purpose information processing equipment such as the computer, and a dedicated translation apparatus may be employed.

FIG. 19 is a flowchart showing an operation procedure of the transmission/reception system 10d shown in FIG. 18.

### Sixth Embodiment

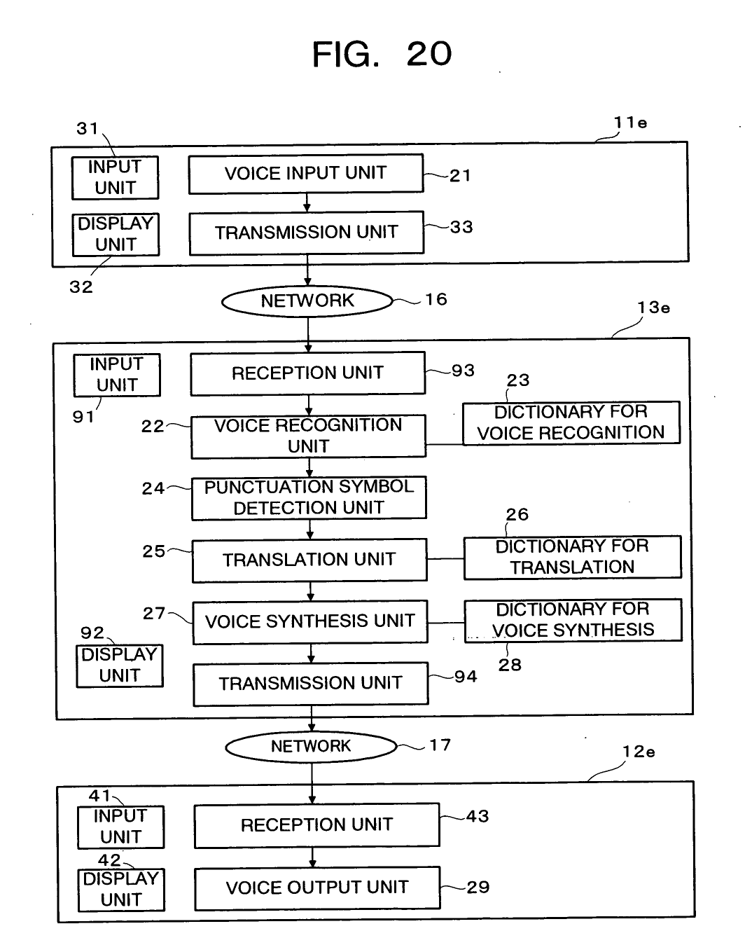

FIG. 20 is a block diagram showing the structure of a transmission/reception system 10e according to a sixth embodiment of the present invention. The transmission/reception system 10e has a transmission apparatus 11e, an interconnection apparatus 13e, and a reception apparatus 12e which are connected via networks 16 and 17. The transmission apparatus 11e includes a voice input unit 21, an input unit 31, a display unit 32, and a transmission unit 33. The interconnection apparatus 13e includes a voice recognition unit 22, a dictionary for voice recognition 23, a punctuation symbol detection unit 24, a translation unit 25, a dictionary for translation 26, a voice synthesis unit 27, a dictionary for voice synthesis 28, an input unit 91, an output unit 92, a reception unit 93, and a transmission unit 94. The reception apparatus 12e includes a voice output unit 29, an input unit 41, a display unit 42, and a reception unit 43.

According to this embodiment, each of the transmission apparatus 11e and the reception apparatus 12e has the simple structure, and a common cellular phone or the like can be applied to the transmission apparatus 11e or the reception apparatus 12e.

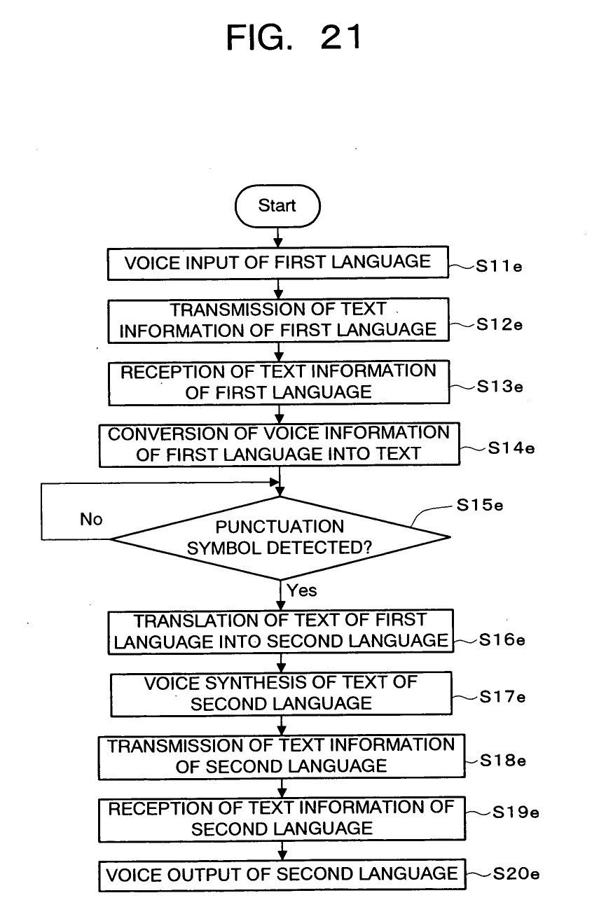

FIG. 21 is a flowchart showing an operation procedure of the transmission/reception system 10e shown in FIG. 20.

### Other Embodiments

Embodiments of the present invention are not limited to the above-described embodiments, and extension and changes may be made. Such extended and changed embodiments are also included in the technical scope of the present invention.

According to the above-described embodiments, the transmission and reception are performed in one direction from the transmission apparatus to the reception apparatus. However, a transmission/reception apparatus which can perform both of the transmission and reception may be employed, instead of the transmission apparatus and the reception apparatus. Being thus constituted, bi-directional communication is made possible and, for example, a telephone system can be realized. In this case, the transmission/reception apparatus may be established to have the same display screen as shown in FIG. 3.

What is claimed is:

1. A translation apparatus comprising:
a punctuation symbol detection unit detecting whether a predetermined punctuation symbol exists or not in text information of a first language; and
a translation unit translating the text information of the first language into text information of a second language which is different from the first language, when the punctuation symbol is detected by said punctuation symbol detection unit.

2. The translation apparatus according to claim 1, further comprising:
a reception unit receiving the text information of the first language.

3. The translation apparatus according to claim 1, further comprising:
a transmission unit transmitting the translated text information of the second language.

4. The translation apparatus according to claim 3, further comprising:
a reception unit receiving the text information of the second language transmitted from said transmission unit.

5. The translation apparatus according to claim 1, further comprising:
a voice recognition unit converting voice information of the first language into the text information of the first language.

6. The translation apparatus according to claim 5,
wherein said voice recognition unit converts explicit punctuation in the voice information of the first language into implicit punctuation symbols in the text information of the first language.

7. The translation apparatus according to claim 5,
wherein said voice recognition unit converts implicit punctuation in the voice information of the first language into explicit punctuation symbols in the text information of the first language.

8. The translation apparatus according to claim 5, further comprising:
a reception unit receiving the voice information of the first language.

9. The translation apparatus according to claim 5, further comprising:
a voice input unit inputting the voice information of the first language.

10. The translation apparatus according to claim 9, further comprising:
a transmission unit transmitting the voice information of the first language which is inputted at said voice input unit; and
a reception unit receiving the text information of the first language which is transmitted at said transmission unit.

11. The translation apparatus according to claim 1, further comprising:
a voice synthesis unit converting the text information of the second language into voice information.

12. The translation apparatus according to claim 11, further comprising:
a transmission unit transmitting the voice information of the second language which is converted at said voice synthesis unit; and
a reception unit receiving the voice information of the second language which is transmitted at said transmission unit.
